(19) United States
(12) Patent Application Publication
(10) Pub. No.: US 2026/0236808 A1
(43) Pub. Date: Aug. 13, 2026

(54) FCTAB-GEN: A FRAMEWORK FOR GENERATING A FUNCTION CALL TOKEN ATTRIBUTION BENCHMARK TO DEVELOP LLM EXPLAINABILITY

(71) Applicant: Oracle International Corporation, Redwood Shores, CA (US)

(72) Inventors: Farouk Boukil, Zurich (CH); Yasha Pushak, Vancouver (CA); Hesam Fathi Moghadam, Sunnyvale, CA (US); Ali Seyfi, Vancouver (CA); Rhicheek Patra, Zurich (CH)

(21) Appl. No.: 19/421,290

(22) Filed: Dec. 16, 2025

Related U.S. Application Data
(60) Provisional application No. 63/757,435, filed on Feb. 12, 2025.

(51) Int. Cl. G06N 5/045; G06F 40/284

(52) U.S. Cl. CPC G06N 5/045; G06F 40/284

(57) ABSTRACT

Here are self-supervised ways of measuring accuracy of a token attribution explainer. A first computer receives an unmasked prompt that is a prompt (sequence of lexical tokens) that includes a natural language request (NLR) and an inferentially generated source logic (IGSL) that can execute the NLR. There are the unmasked, a less-masked, a more-masked, and a fully-masked prompts. Many accuracy scores are generated, including the following (A)-(B) for each of multiple explainers. A) The explainer generates, for each of the prompts, a local explanation that contains a token attribution score for each token in the prompt. B) From the multiple local explanations from the explainer, an accuracy score of the explainer is generated. A most accurate explainer (MAE) is deployed to a second computer without the other explainers. The MAE generates and displays a local explanation of a new IGSL that can execute a new NLR.

### BENEFIT CLAIM

This application claims the benefit of Provisional Application 63/757,435, filed Feb. 12, 2025, the entire contents of which are hereby incorporated by reference as if fully set forth herein, under 35 U.S.C. § 119(e).

### FIELD OF THE INVENTION

Herein are self-supervised ways that are faster and more accurate at measuring accuracy of a large language model (LLM) token attribution explainer.

### BACKGROUND

Explainability methods in Artificial Intelligence (AI) reveal how machine learning (ML) models make decisions by using tools such as feature attribution to trace the influence of model inputs on model outputs. This transparency helps ensure safe use of AI, such as in critical fields. In Natural Language (NL) Processing (NLP), feature attribution identifies the impact of individual elements (e.g., words or phrases) on a model's predictions, providing insights into the often opaque mechanisms of complex models such as large language models (LLMs). By assigning numerical importance values to features, attribution-based explaining exposes the reasons behind specific model outputs and enhances human interpretability.

State of the art importance attribution in NLP lacks benchmarks specifically tailored for evaluating and comparing different attribution methods for language models, which hinders progress and slows the development of new approaches in this technologic field. The following are state of the art ways of feature attribution. Attention methods leverage the attention mechanism often found in neural networks, particularly transformers. Attention weights are used to indicate which parts of the input the model is focusing on when making a prediction. These weights can be interpreted as feature importance scores. Gradient methods calculate the gradients of the model's output with respect to the input features. The magnitude of the gradient is then used as a proxy for feature importance.

Attention-Gradient methods combine the strengths of both attention and gradient methods. They often use attention weights to guide or refine gradient-based attribution, aiming to produce more accurate and interpretable explanations. Perturbation-based methods assess feature importance by measuring how the model's output changes when specific input features are perturbed (e.g., masked). Features that cause larger changes in the output are considered more important. LIME is a successful variant of this approach. Vector analysis methods is a broad category that encompasses methods that analyze the internal representations of the model (e.g. activations of neurons) to reveal feature importance. These methods might involve techniques like analyzing the direction of activation vectors or measuring the similarity between different representations.

Herein, bidirectional encoder representations for transformers (BERT) and generative pretrained transformer (GPT) are interchangeable or equivalent opensource implementations of a general-purpose LLM that is a pretrained deep neural network (DNN) for NLP. An LLM is a powerful language model that may rely heavily on the structure and patterns of NL to understand and process meaningful text. Diction and phrasing, being the arrangement of words and phrases in a sentence, significantly affect an LLM's accuracy for the following reasons.

An LLM's contextual comprehension may be affected by semantics such as dependency relationships between words in an NL prompt that the LLM accepts as input. The LLM learns how words relate to each other syntactically, which aids in comprehension of the overall meaning of a sentence. For example, recognizing a subject-verb-object structure helps the LLM infer causes and effects. Syntactic information provides structural clues that help the LLM disambiguate words with multiple meanings by considering the context in which a word is used. The accuracy of an NL prompt may be measured by measuring the accuracy of an inference from the prompt. That is, natural language may be measurably inaccurate. For example, the accuracy of a generated summary is measurable, where the summary is clear prose (i.e. NL) that is inferred from less clear prose by learned summarization.

### BRIEF DESCRIPTION OF THE DRAWINGS

In the drawings:

FIG. 1 is a block diagram that depicts an example system that has self-supervised ways that are faster and more accurate at measuring accuracy of token attribution explainers;

FIG. 2 is a flow diagram that depicts an example self-supervised computer process that is faster and more accurate at measuring accuracy of token attribution explainers;

FIG. 3 is a dataflow diagram that depicts example processing by the self-supervised Function Call Token Attribution Benchmark Generation (FCTAB-Gen) algorithm that generates an unmasked corpus;

FIG. 4 is a flow diagram that depicts an example self-supervised activities for measuring accuracy of token attribution explainers;

FIG. 5 shows example equations that are explainer accuracy metrics;

FIG. 6 is a block diagram that illustrates a computer system upon which an embodiment of the invention may be implemented;

FIG. 7 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

Here are self-supervised ways that are faster and more accurate at measuring accuracy of a large language model (LLM) token attribution explainer. Referred to as Function Call Token Attribution Benchmark Generation (FCTAB-Gen), this approach includes a robust algorithm for generating a dataset to evaluate token attribution methods with the aim of developing explainability methods for language models. This is the first benchmark specifically for evaluating state of the art token attribution methods for language models. Here also is the first algorithm specifically for generating such a benchmark. This involves fidelity (i.e. explainer accuracy) evaluation techniques having good performance on a synthetic benchmark. Fidelity evaluation is nontrivial for popular token attribution methods and the introduced evaluation methodologies.

An LLM accepts text that is a linguistic prompt as a whole input. This approach identifies specific input regions in the linguistic prompt where a well-trained LLM would assign the highest importance when solving a computer programing task by generating source logic that would invoke exactly one of some predefined subroutines. This consists of generating a subroutine invocation expression (e.g. statement) in a programing language. The programing task is essentially a word problem expressed as NL prose within the prompt. The LLM can malfunction by miscomprehending the given task, by generating logic that will not parse, by selecting the wrong predefined subroutine, or by providing the wrong values or ordering of arguments to the subroutine.

The LLM herein does not significantly malfunction unless part of the linguistic prompt is perturbed, and the magnitude (i.e. severity) of the malfunction is measurable later herein. For ML explanation generation, perturbation importance herein measures which regions of the linguistic prompt are most likely to cause a malfunction when perturbed. Herein is ML explainability (MLX) and explainable artificial intelligence (XAI) for a generative LLM such as a source logic generator such as a coding assistant in an integrated development environment (IDE).

This approach has at least the following innovations. Automated benchmark generation for evaluating feature attribution methods is as follows. This benchmark generation algorithm requires no human-in-the-loop thanks to mitigating, by design, the risk of language model hallucination, leading to higher quality samples. Quality evaluation of token attribution methods is as follows. The samples generated by this algorithm can be used to measure a benchmark to evaluate the quality of token attribution methods for explaining the predictions of language models. Herein, information theory metrics are used to evaluate the quality of these explanation methods. Interpretability evaluation of token attribution methods is as follows. The same samples can also be used to assess the interpretability of token attributions from a human perspective. For example, if an explainer produces noisy attributions, it becomes challenging for a human observer to visually discern which tokens are the most significant. Herein are four innovative metrics to evaluate the quality of token attribution methods in text generation.

This approach provides at least the following advantages. Customizability is provided because the generated evaluation examples can be made more diverse or more specific to a field by adapting the list of topics and function descriptions provided to the algorithm. Robustness is provided because the algorithm minimizes the risk of hallucination in generating the ground truths for the function calls required to solve the tasks. The benchmark generated by this algorithm is challenging for token attribution methods. The examples include both relevant and irrelevant information for generating the appropriate function call, increasing the difficulty of estimating token attributions. Furthermore, the functions appear in an example feature in a random order, hedging against potential positional bias of token attribution methods. Faithfulness (i.e. fidelity) evaluation without ground truths is as follows. The faithfulness evaluation metrics enable evaluating the quality of a token attribution without requiring a ground truth output, as any generation can be used to evaluate the quality of the method, even if the model fails to exactly perform the required task. Accurate ground truths for interpretability evaluation is as follows. The algorithm provides the exact offsets of the relevant regions in the input text, which enables accurate interpretability evaluation.

### 1.0 Example System Of Computer(s)

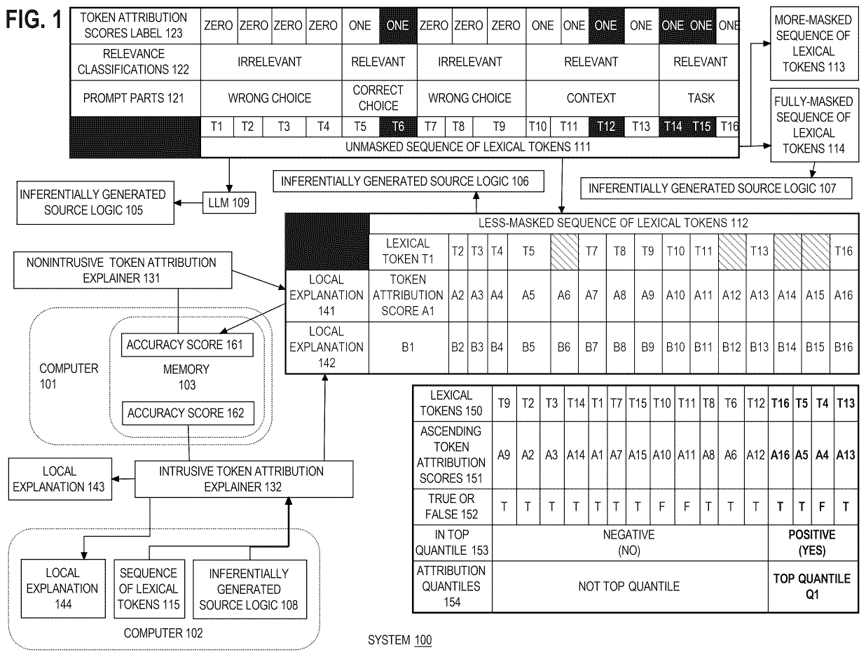

FIG. 1 is a block diagram that depicts example system 100 that has self-supervised ways that are faster and more accurate at measuring accuracy of explainers for large language models (LLMs) such as token attribution explainers 131-132. In an embodiment, computers 101-102 are a same single computer. In an embodiment, system 100 is a distributed system of distinct computers 101-102 that may be interconnected by a communication network. Each of computers 101-102 may be one or more computers such as a rack server such as a blade, a personal computer, a mainframe, or a virtual computer.

All components shown in FIG. 1 may be respectively stored and operated in volatile or nonvolatile storage of computer 101 or 102. As discussed later herein, accuracy scores 161-162 are stored in memory 103 in computer 101 that may be volatile memory for acceleration. In an embodiment, computer 102 contains only components 108, 115, and 144; and computer 101 contains all of the many remaining components shown in FIG. 1. For maximum acceleration in an embodiment not shown, all components in computer 101 are stored in memory 103 that is volatile. In an embodiment, a single token attribution explainer (e.g. 132) is the only component that is replicated (i.e. stored) in both computers 101-102 as discussed later herein.

### 1.1 Large Language Model (LLM) Previously Accepted Linguistic Prompt as Whole Input

LLM 109 already was fully trained for general generative natural language processing (NLP) and source logic generation. Unmasked sequence of lexical tokens 111 is text that is a natural language prompt that LLM 109 previously accepted as a whole input, and LLM 109 already responsively inferred inferentially generated source logic 105. In some scenarios discussed later herein, the less accurate are components 105 and 109, the more operationally useful are local explanations generated by the approach herein, such as detecting that an explainer is too inaccurate for service. In other scenarios discussed later herein, the more accurate are components 105 and 109, the more operationally useful are local explanations generated by the approach herein, such as selecting a most accurate explainer from multiple available explainers. For example, accuracies of two explainers may be compared and, in an embodiment not shown, the two explainers may be: a) two differently configured instances of a same explainer architecture or b) two different versions (e.g. build or release) of a same explainer architecture. As shown and as discussed later herein, token attribution explainers 131-132 have distinct respective explainer architectures.

Each of many linguistic prompts such as sequences of lexical tokens 111 and 115 have a same general composition that consists of a same sequence of prompt parts. For example as shown, unmasked sequence of lexical tokens 111 consists of prompt parts 121 that sequentially are in this example: wrong choice, correct choice, wrong choice, context, and task. In this example: a) the context part and the task part consist solely of natural language; and b) each choice is text that, in an embodiment, contains a mix of natural language and programing language. In this example, the choice parts and inferentially generated source logic 105 are expressed in a same programing language. Each prompt part consists of a respective disjoint (i.e. nonoverlapping, not share tokens) subsequence of a whole linguistic prompt. For example as shown in unmasked sequence of lexical tokens 111, the correct choice part consists of lexical tokens T5-T6.

### 1.2 Self-Supervised Token Relevance

Relevance classifications 122 are self-supervised non-learned characterizations of respective parts of prompt parts 121. A prompt part may be binary classified as relevant or irrelevant, with respect to whether the prompt part should or should not have influenced inferential operation of LLM 109. The context part and the task part are predefined (i.e. pre-classified) as relevant. The task part, also referred to herein as a natural language request, is a question or other verbal request, and inferentially generated source logic 105 was generated to fulfill the natural language request if inferentially generated source logic 105 would be executed.

The approach herein is analytic and does not require execution of inferentially generated source logic 105. For example, inferentially generated source logic 105 may be a Python script, and an embodiment of system 100 may be unable to execute Python. Python is a dynamically-typed, imperative, and interpreted language. Other example source logic languages include structured query language (SQL) that is declarative (i.e. not imperative) and C that is statically typed, imperative, and compiled (i.e. not interpreted).

The context part provides scenario and background information that supplements the task part. The task part and the context part may contain a mix of relevant and irrelevant lexical tokens that should or should not influence LLM 109.

In this embodiment, the correct choice part is the only choice part that is relevant to the natural language request. The two wrong choice parts are randomly selected from many predefined choices, and the wrong choice parts were included in the linguistic prompt for the sole purpose of confusing LLM 109. Thus, the two wrong choices are classified as irrelevant as shown. Token attribution scores label 123 is a self-supervised (i.e. automatically non-learned generated) validation label that consists of a token attribution score for each of lexical tokens T1-T16 in unmasked sequence of lexical tokens 111.

Herein, a token attribution score is a real number in a range of zero to one or in a range of negative one to positive one. A token attribution score of zero indicates that the lexical token was irrelevant to the internal operation of LLM 109. A token attribution score of one indicates that the lexical token was maximally relevant to the internal operation of LLM 109. A negative token attribution score indicates that the lexical token was relevant to the internal operation of LLM 109 in a way that decreased the likelihood or confidence that LLM 109 should exactly infer inferentially generated source logic 105. That is, a negative token attribution score contradicts inferentially generated source logic 105, but not enough to cause LLM 109 to generate a different source logic.

### 1.3 Various Maskings of Tokens

As shown in token attribution scores label 123, all relevant lexical tokens T5-T6 and T10-T16 have a token attribution score of maximal one, and all irrelevant lexical tokens T1-T4 and T7-T9 have a token attribution score of minimal zero. This self-supervision may be slightly imperfect and does not mean that, for example, lexical token T5 is actually relevant as discussed later herein. Distinct token attribution explainers 131-132 may somewhat disagree as to what token attribution scores should lexical tokens T1-T16 have. In unmasked sequence of lexical tokens 111, lexical tokens T6, T12, and T14-T15 are shown shaded dark, as are corresponding values in token attribution scores label 123. That shading indicates masking of some individual tokens to generate less-masked sequence of lexical tokens 112 as discussed below.

For increased accuracy of token attribution scores, such as A1-A16 and B1-B16, by varied repeated invocations of token attribution explainers 131-132, partially or entirely masked sequences of lexical tokens 112-114 are generated as imperfect (i.e. lossy) copies of original unmasked sequence of lexical tokens 111. For example in less-masked sequence of lexical tokens 112, four lexical tokens T6, T12, and T14-T15 are demonstratively shown with a hatched background to indicate that those four tokens are masked. A masked token is a token that has been replaced with a predefined meaningless lexical token that does not occur in any unmasked sequence of lexical tokens. Ideally, a masked token would not influence internal operation of LLM 109. The robust approach herein works even if a small subset of the masked tokens wrongly influence LLM 109.

Less-masked sequence of lexical tokens 112 has 4 masked tokens/16 total tokens=twenty-five percent of the tokens are masked, and seventy-five percent of the tokens are unmasked. Less-masked sequence of lexical tokens 112 consists of mostly (i.e. more than half, i.e. >50%) unmasked tokens, and more-masked sequence of lexical tokens 113 instead consists of mostly masked tokens. The percentage (i.e. 25%) of tokens masked in less-masked sequence of lexical tokens 112 is equal to the percentage of tokens unmasked in more-masked sequence of lexical tokens 112. The percentage (i.e. 75%) of tokens unmasked in less-masked sequence of lexical tokens 112 is equal to the percentage of tokens masked in more-masked sequence of lexical tokens 112. All lexical tokens T1-T16 are masked in fully-masked sequence of lexical tokens 114. None of lexical tokens T1-T16 are masked in unmasked sequence of lexical tokens 111.

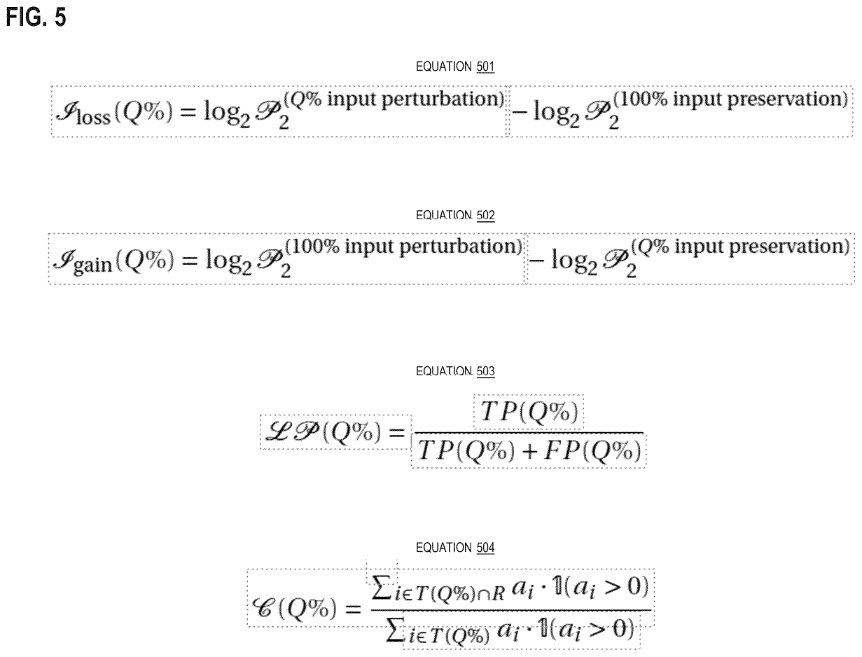

An embodiment discussed later herein has only one hyperparameter Q (shown in FIG. 5), and this hyperparameter is a positive fraction not exceeding a half, such as an integer percentage from one to fifty. That fraction Q specifies what percentage of tokens to mask in less-masked sequence of lexical tokens 112 and the percentage to leave unmasked in more-masked sequence of lexical tokens 113. As discussed later herein, that fraction also specifies the size of the value range of top quantile Q1 (shown in FIG. 1) that is a quartile if the percentage is 25%.

### 1.4 Multiple Available Explainers

Herein, a datapoint is a distinct pair of a text input to LLM 109 and the responsive text output from LLM 109. That is, a datapoint is a distinct pair of a sequence of lexical tokens and an inferentially generated source logic that the token sequence caused. For example, the pair of shown texts 105 and 111 is one datapoint, and the pair of shown texts 106 and 112 is another datapoint. Herein, there are multiple distinct datapoints per unmasked sequence of lexical tokens because three variously masked sequences of lexical tokens are generated from one unmasked sequence. For example, variously masked sequences of lexical tokens 112-114 are generated from unmasked sequence of lexical tokens 111. Thus, herein a masked corpus (not shown) is four times the size of, and includes, the unmasked corpus (not shown) of multiple unmasked sequences of lexical tokens from which the masked corpus was generated. Herein, each datapoint has multiple local explanations, which is one local explanation generated from each of all two token attribution explainers 131-132. Thus from a minimal unmasked corpus consisting of a single pair of texts 105 and 111, a masked corpus of four datapoints (i.e. pairs) is generated and, from the masked corpus, 4 datapoints×2 explainers=eight local explanations are generated.

For example from the one datapoint pair of texts 106 and 112, two local explanations 141-142 are generated by respective token attribution explainers 131-132. Herein, a local explanation of a datapoint is entirely numeric and is an array of token attribution scores, which is one attribution score per token in the sequence of lexical tokens in the datapoint. For example as shown, local explanation 141 consists of sixteen token attribution scores A1-A16 respectively for the sixteen tokens in less-masked sequence of lexical tokens 112. Even masked tokens have attribution scores in local explanation 141. Likewise, local explanation 142 consists of sixteen token attribution scores B1-B16 respectively for the same sixteen tokens in less-masked sequence of lexical tokens 112. For example, one of local explanations 141-142 may be more accurate than the other and, by measuring accuracy scores 161-162 by processing the many local explanations generated for the many distinct datapoints of the entire masked corpus, one of token attribution explainers 131-132 may be selected as more accurate than the other.

### 1.5 Kinds of Explainers

Attention explainers leverage the attention mechanism often found in neural networks, particularly transformers. Attention weights are used to indicate which parts of the input the model is focusing on when making a prediction. These weights can be interpreted as feature importance scores. Gradient explainers calculate the gradients of the model's output with respect to the input features. The magnitude of the gradient is then used as a proxy for feature importance.

Attention-Gradient explainers combine the strengths of both attention and gradient methods. They often use attention weights to guide or refine gradient-based attribution, aiming to produce more accurate and interpretable explanations. Perturbation-based explainers assess feature importance by measuring how the model's output changes when specific input features are perturbed (e.g., masked). Features that cause larger changes in the output are considered more important. Locally interpretable model-agnostic explanations (LIME) is a successful variant of this approach. Vector analysis explainers is a broad category that encompasses explainers that analyze the internal representations of the model (e.g. activations of neurons) to reveal feature importance. Vector methods might involve techniques like analyzing the direction of activation vectors or measuring the similarity between different representations.

A taxonomy of token attribution explainer types consists of model-agnostic explainers that can explain an opaque (i.e. black box) LLM and model-specific explainers that need to inspect the internals of the LLM. Model-specific explainers consist of intrusive explainers that need to instrument (i.e. modify) the internals of the LLM and nonintrusive explainers that do not modify the LLM. All model-agnostic explainers also are nonintrusive. Only perturbation explainers are model agnostic. Only attention and attention-gradient explainers are intrusive.

### 1.6 Comparison of Explainers and Selection of Best Explainer

Each of token attribution explainers 131-132 may generate a local explanation for each of sequences of lexical tokens 111-114. For example, intrusive token attribution explainer 132 may generate local explanation 143 for unmasked sequence of lexical tokens 111. Each of local explanations 141-143 contains sixteen token attribution scores. The sixteen scores in local explanation 143 are not the sixteen scores in token attribution scores label 123, even though both sets of sixteen scores are generated for a same unmasked sequence of lexical tokens 111. For example, relevance classifications 122 indicates that token T10 is relevant, but local explanation 143 may disagree.

For a single datapoint, a single local explanation may be generated by a single token attribution explainer whose internal operation may entail many exploratory invocations of LLM 109, with the exploration steered by the explainer. For example, some token attribution explainer(s) may generate unshown multiple distinct sequences of lexical tokens that are imperfect copies of any one of sequences of lexical tokens 111-114. For example, some token attribution explainer(s) may or may not use token masking to generate an imperfect copy that is a likely-unique tokens sequence.

The shown embodiment performs explainer selection where the goal is to self-supervised select (i.e. discover) a most accurate token attribution explainer from many available token attribution explainers. In one unshown embodiment, the goal instead is to statically self-supervised validate (i.e. acceptance test) one token attribution explainer as a precondition of deployment into production. In another unshown embodiment, the goal instead is to dynamically test (i.e. drift detection) one token attribution explainer that already is in production as a postcondition for remaining in production without adjustment or replacement. An example lifecycle of system 100 may entail explainer selection after any finetuning, retraining, or replacement of LLM 109. In the shown example as discussed later herein, intrusive token attribution explainer 132 is selected as the best explainer that is the most accurate explainer, such as based on a comparison of accuracy scores 161-162 of respective token attribution explainers 131-132.

### 1.7 Data Structures and Quantitative Analytics for Explainer accuracy measurement

More datapoints in the unmasked corpus increases the accuracy of accuracy scores 161-162. More datapoints in the unmasked corpus and/or more token attribution explainers increases the accuracy of components 100, 102, and 144 due to increased likelihood that the shown embodiment will select the actual best token attribution explainer from all available token attribution explainers 131-132. Innovative measurement of explainer accuracy is as follows and as discussed later herein.

Measurement of accuracy of local explanation 141 is shown in the lower right corner of FIG. 1 as a shown table that demonstratively shows components 150-154 as respective table rows, which does not mean that an embodiment will use a similar table or any data table for explanation accuracy measurement. Shown components 150-154 cooperate as follows for explanation accuracy measurement. Ascending token attribution scores 151 is demonstrative and, for example, may be unimplemented in an embodiment. Ascending token attribution scores 151 are token attribution scores A1-A16 ascending sorted. For example as shown in ascending token attribution scores 151, token attribution score A9 is the lowest, and token attribution score A13 is the highest. Lexical tokens 150 are the sixteen tokens in less-masked sequence of lexical tokens 112 ascending sorted by token attribution score. For example as shown in lexical tokens 150, lexical token T9 has the lowest attribution score, and lexical token T13 has the highest attribution score.

As discussed earlier herein, top quantile Q1 is a quartile in this example. For quantitative analytics herein, top quantile Q1 contains lexical tokens T4-T5, T13, and T16 that nonintrusive token attribution explainer 131 selected as the most relevant. For example, four lexical tokens T4-T5, T13, and T16 are indicated as the most relevant in local explanation 141, which does not means that those are the four most relevant tokens as indicated in other local explanation 142 for the same datapoint. That is, token attribution explainers 131-132 may somewhat disagree as to token relevance, and the shown embodiment uses that disagreement (i.e. as reflected in accuracy scores 161-162) to more accurately select a best (i.e. most accurate) explainer. For example, the more disagreement between token attribution explainers 131-132, the greater may be the arithmetic difference between accuracy scores 161-162.

In top quantile 153 indicates negative or positive (i.e. yes or no) as to whether each of lexical tokens T1-T16 is in top quantile Q1. Here, a positive token means that the token attribution explainer rightly or wrongly decided that the token is one of the few most relevant. Negative instead means that the token attribution explainer rightly or wrongly decided that the token is not one of the few most relevant, which does not mean that the token's attribution score is low. For example, a negative token may have high relevance according to the token attribution explainer but not high enough for inclusion in top quantile Q1.

For each of lexical tokens T1-T16, true or false 152 distinguishes true positives from false positives and true negatives from false negatives. For example, one confusion matrix may implement both of components 152-153, and the confusion matrix may consist of only four tallies (i.e. counts, i.e. whole numbers, i.e. nonnegative integers), no matter how many (e.g. sixteen) lexical tokens are tallied into the confusion matrix. The four counts in the confusion matrix are: true positives, false positives, true negatives, and false negatives. Herein, truth and falsity may be detected by comparison of components 123 and 152, where zero and one in token attribution scores label 123 are respectively mapped to false and true.

For example, a true positive is a lexical token whose value is one in token attribution scores label 123 and whose value is true in true or false 152. Likewise, a false negative is a lexical token whose value is one in token attribution scores label 123 and whose value instead is false in true or false 152. For example as shown in components 152-153: a) lexical token T9 is a true negative; b) lexical token T10 is a false negative; c) lexical token T16 is a true positive; and d) lexical token T4 is a false positive.

Accuracy score 161 is measured from components 152-153 or from the confusion matrix. Accuracy score 161 may be a single scalar score (i.e. number), no matter how many datapoints are in the masked corpus and no matter how many tokens are in each sequence of lexical tokens. Quantitative analytics for measuring accuracy score 161 are discussed later for FIG. 5. As discussed earlier herein, a validation embodiment may implement either static acceptance testing or dynamic drift detection. In either validation embodiment: a) there is only one token attribution explainer; b) the explainer passes validation only if the accuracy score of the explainer exceeds a predefined validation threshold. For example, nonintrusive token attribution explainer 131 fails validation if accuracy score 161 does not exceed the validation threshold.

In the shown explainer selection embodiment, intrusive token attribution explainer 132 is selected as a best (i.e. most accurate) explainer if accuracy score 162 exceeds accuracy score 161. Only (i.e. without any other explainers, e.g. without nonintrusive token attribution explainer 131) the selected best explainer is deployed into computer 102 for production use. After deployment, the best token attribution explainer may accept new texts 108 and 115 and responsively generate best (i.e. most accurate) local explanation 144.

### 2.0 Example Faster and More Accurate Process for Measuring Explainer Accuracy

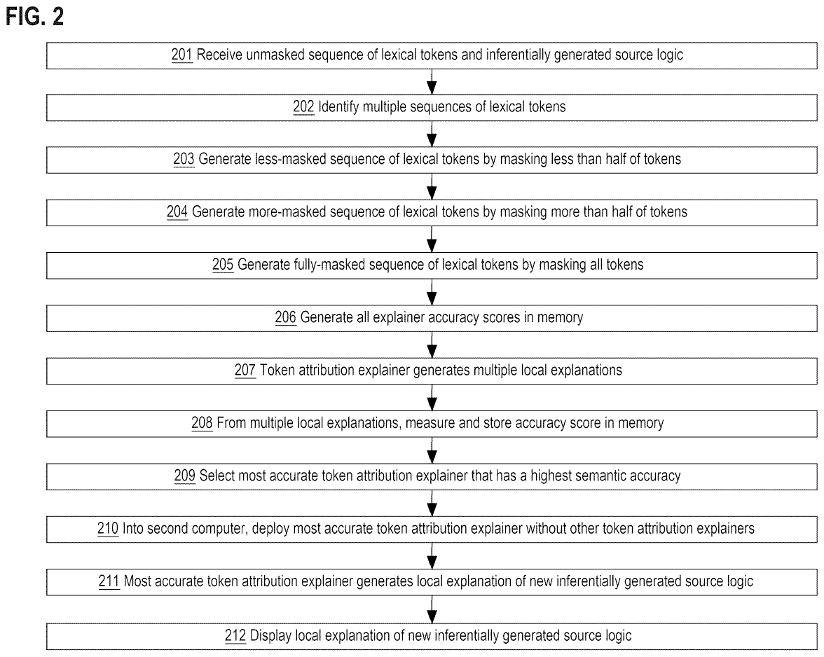

FIG. 2 is a flow diagram that depicts an example computer process that system 100 performs to apply self-supervised ways that are faster and more accurate at measuring accuracy of token attribution explainers 131-132. The embodiment shown in FIG. 2 performs self-supervised selection and production deployment and use of a most accurate token attribution explainer (e.g. 132 as shown in FIG. 1). Computer 101 performs explainer selection that entails a single (i.e. unsampled) pass over the unmasked corpus that entails steps 201-209. Computers 101-102 cooperate in step 210 to deploy the best (i.e. most accurate) token attribution explainer into production. Computer 102 performs production use of the most accurate token attribution explainer that entails steps 211-212. In an embodiment, computers 101-102 are a same single computer.

Step 201 receives (e.g. retrieves from the unmasked corpus) an unmasked datapoint that consists of unmasked sequence of lexical tokens 111 and inferentially generated source logic 105. Steps 201-208 may be repeated for each datapoint from a single pass over the unmasked corpus. Including the unmasked datapoint, step 202 identifies four sequences of lexical tokens 111-114. Steps 203-205 are three sub-steps of step 202 that generate three respective variously masked sequences of lexical tokens that are three imperfect copies of unmasked sequence of lexical tokens 111. Steps 203-206 cooperate to generate the masked corpus that has four times as many datapoints as the original unmasked corpus.

As discussed earlier and as shown in FIG. 1, lexical tokens 150 are sorted by ascending token attribution scores 151 that are generated from less-masked sequence of lexical tokens 112. Likewise and although not shown in FIG. 1, unmasked sequence of lexical tokens 111 may be sorted by ascending token attribution scores label 123. In the example shown in FIG. 1, top quantile Q1 is a quartile and, in that case, none of irrelevant lexical tokens T1-T4 and T7-T9 would be in the top quartile for unmasked sequence of lexical tokens 111 based on token attribution scores label 123. As shown in token attribution scores label 123, nine relevant lexical tokens T5-T6 and T10-T16 have the maximum attribution score that is one. Nine relevant tokens is too many to be included in the top quartile that should only contain four tokens, which is 16 tokens/4 quartiles=four tokens per quartile. To avoid bias when determining which tokens should be in the top quantile based on token attribution scores label 123, tokens with identical scores should have score ties resolved randomly. For example, both of lexical tokens T5 and T10 have a same attribution score of one in token attribution scores label 123. In that case, which one of lexical tokens T5 and T12 would be treated for sorting as having a higher attribution score should be randomly decided to avoid bias. For example as shown in unmasked sequence of lexical tokens 111, lexical tokens T5-T6 that have a same attribution score of one in token attribution scores label 123 are shown differently shaded to demonstrate that random resolution of score ties caused: a) sorting lexical token T6 into the top quartile and b) sorting lexical token T5 into a different quartile.

Steps 203-204 are both based on a same top quantile of token attribution scores label 123. However, steps 203-204 differently decide which lexical tokens to mask based on that same top quantile as follows. Step 203 generates less-masked sequence of lexical tokens 112 by masking less than half of lexical tokens T1-T16, which are only those lexical tokens (i.e. T6, T12, and T14-T15 shown shaded in FIG. 1) in the top quantile of token attribution scores 123.

Step 204 generates more-masked sequence of lexical tokens 113 by masking more than half of lexical tokens T1-T16, which are only those tokens that are not in the top quantile of token attribution scores 123, which is the opposite of step 203. In an embodiment, step 204 may mask exactly those tokens that step 203 does not mask and, conversely, step 203 may mask exactly those tokens that step 204 does not mask. For example, less-masked sequence of lexical tokens 112 masks tokens shown shaded in token attribution scores label 123, and more-masked sequence of lexical tokens 113 instead masks tokens shown unshaded in token attribution scores label 123. Step 205 generates fully-masked sequence of lexical tokens 114 by masking all of lexical tokens T1-T16.

Step 206 generates all explainer accuracy scores 161-162 in memory 103. In a maximally accelerated embodiment not shown in FIG. 1, any data component shown in FIG. 1 that computer 101 accesses is stored in memory 103 that is volatile. Steps 207-208 may be sub-steps of step 206. Steps 207-208 are repeated for each of all available token attribution explainers 131-132. In step 207, the token attribution explainer (e.g. 131) generates four local explanations (i.e. including 141) respectively for four sequences of lexical tokens 111-114. For nonintrusive token attribution explainer 131 and an unmasked corpus that contains two datapoints, step 207 generates 2 unmasked datapoints×4 explanations per unmasked datapoint=eight local explanations, plus an additional eight local explanations for intrusive token attribution explainer 132.

From multiple (i.e. a multiple of four, e.g. eight as discussed above) local explanations, step 208 measures and stores exactly one scalar accuracy score into memory 103. Measurement by step 208 is discussed later for FIG. 5. Herein, explainer accuracy may be referred to as fidelity or, due to semantics of input and output of LLM 109, semantic accuracy. Step 209 selects the most accurate token attribution explainer (e.g. 132) that has the highest semantic accuracy. For example, step 209 reads memory 103 to detect that one (e.g. 162) of all accuracy scores 161-162 is the highest.

Into computer 102, step 210 deploys the most accurate token attribution explainer (e.g. 132) without other token attribution explainer(s) (e.g. 131). That is, step 210 puts only the most accurate token attribution explainer into service. In step 211, the most accurate token attribution explainer (e.g. 132) generates local explanation 144 of a new datapoint that is a new pair that consists of new sequence of lexical tokens 115 and new inferentially generated source logic 108 that was generated from new sequence of lexical tokens 115 by LLM 109. Step 212 displays local explanation 144. In an embodiment, step 212 displays some or all of the tokens in sequence of lexical tokens 115 and/or some or all of the token attribution scores in local explanation 144.

### 3.0 Example Function Call Token Attribution Benchmark Generation (FCTAB-GEN) Algorithm

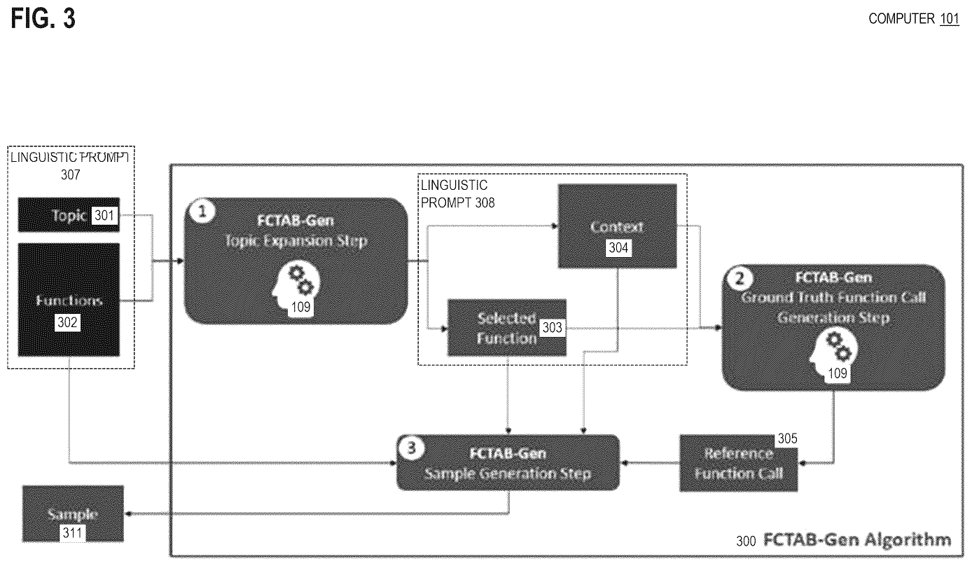

FIG. 3 is a dataflow diagram that depicts example processing by self-supervised Function Call Token Attribution Benchmark Generation (FCTAB-Gen) algorithm 300 that generates the unmasked corpus. Herein, self-supervision is fully automated and does not entail human intervention nor human expertise. FCTAB-Gen algorithm 300 consists of the shown sequence of steps 1-3 that operate as follows.

As discussed earlier for FIG. 1, unmasked sequence of lexical tokens 111 consists of prompt parts 121 that may be logically divided into two halves that are lexical tokens T1-T9 that are choices and lexical tokens T10-T16 that is context that is shown in FIG. 3 as context 304 that consists of a context part and a task part somewhat similar to the context part and task part shown in prompt parts 121 in FIG. 1. As discussed later herein, selected function 303 is one of functions 302. The process of FIG. 3 is preprocessing (i.e. unmasked corpus generation) that is not apparent in FIG. 1 because FIG. 1 presumes a preexisting unmasked corpus that contains unmasked sequence of lexical tokens 111.

### 3.1 Step One: Topic Expansion

Steps 1-3 cooperate to generate the unmasked corpus. Texts 301-302 are input data that are provided together in linguistic prompt 307 that LLM 109 accepts as a whole input in topic expansion step 1. Topic 301 is the name of a knowledge (i.e. subject matter) topic. A topic name (e.g. 301) is a unique string that is a semantic linguistic term such as “Energy Planning”, which is multiword natural language that is a sequence of multiple words but less than a natural sentence. Before topic expansion step 1, topic 301 is randomly selected from many predefined topics (i.e. topic names).

Here is an example set of available predefined topic names. In an embodiment, the topic names and generally trained LLM 109 are needed but, for techniques herein, the topic names do not need to be accompanied by a definition, description, summary, nor topic content. That is, LLM 109 already comprehends these topic names as identifiers of particular knowledge domains of which LLM 109 already generally learned about. For example, LLM 109 already learned that below example topic Energy Consumption is related in particular ways to concepts such as electricity, fuel, seasonality, and price. Additional topics increases corpus diversity, which increases accuracy of scores 161-162. Here, increased scoring accuracy (i.e. fidelity) is not the same as increasing accuracy score 161. For example, fidelity can be high even when accuracy score 161 is low. In an embodiment, there are 200 distinct predefined topics, and the following are twelve of them.
1. Blockchain Analytics
2. Energy Consumption
3. Sentiment Analysis
4. Traffic Prediction
5. Supply Chain Resilience
6. Market Research
7. Risk Management
8. Quality Control
9. R&D Innovation
10. Data Privacy
11. Quantum Security
12. Sports Statistics

Functions 302 are unique declarations (e.g. signatures) of a few (e.g. Python) predefined subroutines. Before topic expansion step 1, each of functions 302 is a string that is randomly selected from many predefined subroutines that are readily available and well documented. Here is an example set of 45 available predefined Python functions that, in this example, all are fundamental to data science.
1. clustering_analysis
2. detect_outliers
3. regression_analysis
4. classification_analysis
5. show_random_sample
6. show_dataset_head
7. show_dataset_tail
8. show_dataset_rows
9. filter_columns
10. show_sorted_dataset
11. check_missing_values
12. unique_values_analysis
13. summarize_data_distribution
14. show_dataset_metadata
15. analyze_correlations
16. calculate_statistic_on_column
17. entropy_analysis
18. calculate_information_gain
19. calculate_kl_divergence
20. check_stationarity
21. detect_seasonality
22. check_auto_correlation
23. predict
24. explain_prediction
25. explain_forecast_steps_ahead
26. explain_forecast_between_dates
27. evaluate_model
28. forecast_steps_ahead
29. forecast_between_dates
30. train_model
31. load_data
32. fill_missing_datetimes
33. fill_na
34. math
35. math_const_value
36. groupby_aggregate
37. groupby_aggregate_time
38. calculate_group_sizes
39. calculate_group_sizes_time
40. join
41. select_columns
42. select_rows
43. filter_rows_const_value
44. filter_rows
45. extract_datetime_components

As discussed earlier for FIG. 1, prompt parts 121 consists of task, context, and multiple choices as parts. The task part and the context part differ as follows. The task part is a question or command. The context part discusses topic 301 in a way that contains some semantics (i.e. facts, knowledge) about topic 301. The context part contains a mix of background (i.e. facts generally about topic 301) and scenario specific facts.

The more knowledge LLM 109 has (e.g. in unmasked sequence of lexical tokens 111 or previously learned) about topic 301, the more of that knowledge will be irrelevant to solving a given narrow problem. Step 1 is discussed below and, after step 1, LLM 109 solves custom programing tasks that are presented as word (i.e. natural language) problems. Each word problem is natural language prose that superficially implicates any exactly one of many predefined topics. LLM 109 is an expert generator of function invocation source logic and has some familiarity or expertise with topic 301. For logic generation, LLM 109 should analyze only a minimum of learned topic knowledge that is directly related to the programing task as presented in context 304. Context 304 may contain information about topic 301, and some of the contained information is accurate within topic 301 but extraneous (i.e. irrelevant) to the programing task. Herein, the programing task is also referred to as the target task.

Step 1 is topic expansion. In some scenarios herein, a topic is a combination of a topic name and some or all information that LLM 109 previously learned (i.e. during training) about that topic. A topic name (e.g. 301) and a random subset (e.g. 302) of predefined Python functions are sampled respectively from many predefined topics and the collection of many Python functions.

Generation of linguistic prompt 307 entails random sampling that selects texts 301-302 as follows. Functions 302 are an amount of randomly sampled functions, where the amount entails a random count within a user-predefined minimum and maximum. For example, different invocations of step 1 may contain different amounts of functions in functions 302. Random sampling of random amounts ensures that sampled functions 302 is diverse, given the distinct respective natures of the functions in the collection. Furthermore, this ensures that the count of functions and their sampled total (i.e. all of their declaration text and documentation combined) size (e.g. characters or multicharacter lexical tokens) is variable across invocations of step 1, offering diversity in addition to diversity introduced by later masking after the process of FIG. 3.

In step 1, LLM 109 processes texts 301-302 as follows. Linguistic prompt 307 is generated that contains texts 301-302 and natural language instructions for LLM 109 to perform two tasks (not shown, i.e. not context 304). LLM 109 accepts linguistic prompt 307 as a whole input, which causes LLM 109 to inferentially perform both tasks as follows.

The first task is to randomly select single selected function 303 from available functions 302. For the second task, linguistic prompt 307 asks LLM 109 to generate a word problem (i.e. context 304) that is based on topic 301 and based on an expected usage of selected function 303. Prompt 307 asks LLM 109 to creatively (i.e. generatively) expand topic 301 into context 304 that describes a target task (i.e. the task part of prompt parts 121) that is solvable only by using selected function 303. Although the target task will be incorporated into context 304, linguistic prompt 307 does not mention what is the target task. That is, context 304 is inferred (i.e. inferentially generated). When linguistic prompt 307 is generated, the target task of context 304 is undefined. Linguistic prompt 307 instead emphasizes that the unspecified target task must satisfy the following two semantic constraints that are not based on topic 301: a) be solvable solely using the unspecified selected function and b) be impossible to solve by instead using any of the other functions in functions 302.

To increase the difficulty and robustness of the unmasked corpus being generated, LLM 109 is further instructed by linguistic prompt 307 to include two additional items into unspecified context 304. The first item is information required to solve the unspecified target task (e.g. function actual arguments, including their values and ordering). The second item is additional task-aligned information that is unnecessary (i.e. irrelevant) for solving the unspecified target task. Irrelevant target task details may, for example, be about the company requesting the target task or extraneous values that should not be used as function arguments.

If step 1 is repeated multiple times for a same topic 301 and for different topics, then there may be many combinatorial pairings of a) sampled subsets of functions with b) sampled topics. This diversifies the unmasked corpus.

### 3.2 Step Two: Ground Truth Baseline

Step 2 is ground truth function call generation that inferentially generates reference function call 305 from linguistic prompt 308. The following is an example reference function call 305.

regression_analysis(
dataset_path=‘/data/energy_consumption.csv’,
target_variable=‘energy_consumption’)

In the following example linguistic prompt 308, curly braces (i.e. {{}}) enclose are placeholders that should be replaced with documentation of a corresponding function. In the following example linguistic prompt 308 is a docstring placeholder. Docstring is a Python documentation string (docstring) that is document generation text that contains natural language that describes a Python function and describes the function's signature. The following is an example linguistic prompt 308 that step 2 accepts as a whole input. In the following example linguistic prompt 308, ‘you’ is LLM 109.

##Selected Python Function (i.e. selected function 303):
def regression_analysis(dataset: str, target_variable: str):
{{docstring of regression_descriptive_analysis}}
##Context Part from FIG. 1:
As an energy planning specialist, you are tasked with analyzing the energy consumption
patterns of a large industrial facility. The facility's energy consumption data is stored in a
dataset called ‘energy_consumption.csv’, which includes columns such as ‘date’, ‘temperature’,
‘humidity’, ‘production_level’, and ‘energy_consumption’. The facility's management wants
to predict future energy consumption to optimize their energy planning and reduce costs.
They are particularly interested in understanding how the production level affects energy
consumption. The dataset is stored on a local server and can be accessed via the ‘/data/energy_
consumption.csv’ path.
##Task (i.e. not task part from FIG. 1):
Assuming the above selected Python function is implemented, your coding task is to directly invoke the single Python
function to solve the above analysis (i.e. target) task.

Accuracy evaluation (e.g. precision) in later step 3 will be supervised by baseline labels that are inferentially generated in steps 1-2 as follows. Herein, a baseline label contains: a) a unique name of a correct (i.e. as selected by step 1) predefined function and b) inferentially generated by LLM 109 in step 2, Python source logic that implements the answer to the word problem (i.e. context). It does not matter if the inferred Python source logic actually is correct because, even if slightly incorrect, perturbation in step 3 is more or less guaranteed to infer a less accurate (i.e. less correct) source logic answer. That is, the steps 2-3 both generate similar Python source logic, and the accuracy of LLM 109 is measured herein by how much the source logic from step 3 differs in comparison to the source logic from step 2. For example, precision of a generative inference may be measured by comparing two Python function invocation expressions or statements, where each of the compared expressions is text that can be treated as a sequence of lexical tokens as discussed later herein.

Given the selected function's definition and documentation as input to step 2, LLM 109 is prompted to solve the task using as input a linguistic prompt 308 that contains only texts 303-304. The goal is to generate the ground truth function call later used in step 3 for interpretability evaluation. Linguistic prompt 308 in step 2 minimizes the risk of LLM 109 mistakenly utilizing a different function or even hallucinating, because the other functions are excluded from the prompt. This has the additional benefit of reducing the cost for generating ground truth function calls, because removing unnecessary function declarations and documentation reduces the input length. That is, identification of a single function in linguistic prompt 308 conserves memory, and the smaller prompt increases the speed and accuracy of LLM 109.

### 3.3 Step Three: Unmasked Corpus Generation

Step 3 is unmasked corpus construction, including generation of unmasked sample 311 that contains: a) unmasked sequence of lexical tokens 111 that contains functions 302 including, without indicating as correct, selected function 303, b) an indication that selected function 303 is the correct choice, and c) respective token offsets into unmasked sequence of lexical tokens 111 for all five of prompt parts 121 as shown in FIG. 1. Sample 311 does not contain token attribution scores label 123 that is not generated until after the process of FIG. 3. That is, the unmasked corpus does not contain token attribution scores label 123. When generating sample 311, functions 302 (including selected function 303) are shuffled (i.e. randomly reordered) to mitigate any potential positional bias by any of components 109 and 131-132.

LLM 109 has perfect unmasked precision (i.e. reliability) when linguistic prompts 111 and 308 cause LLM 109 to infer identical function calls 105 and 305, in respective FIGS. 1 and 3, even though linguistic prompts 111 and 308 are not identical. LLM 109 has perfect masked precision when function calls 106 and 305 are identical, which might indicate that a masked region of a prompt is unimportant (i.e. irrelevant) to inferencing by LLM 109.

The following is an example unmasked sequence of lexical tokens 111 that sample 311 contains. In the following example unmasked sequence of lexical tokens 111, prompt parts 121 contains four choices, although only three choices are shown in FIG. 1.

##Available Python Functions (i.e. choices from FIG. 1):
def filter_rows_const_value(
dataset_name: str,
column_name: str,
operator: str,
value: Union[float, int, bool, str, list, None],
new_dataset_name: str,
):
{{docstring of filter_rows_const_value}}
def calculate_kl_divergence(dataset: str, column1: str, column2: str):
{{docstring of calculate_kl_divergence}}
def regression_analysis(dataset: str, target_variable: str):
{{docstring of regression_descriptive_analysis}}
def clustering_analysis(dataset: str, n_clusters: int=3):
{{docstring of clustering_analysis}}
##Context Part from FIG. 1:

As an energy planning specialist, you are tasked with analyzing the energy consumption

patterns of a large industrial facility. The facility's energy consumption data is stored in a
dataset called ‘energy_consumption.csv’, which includes columns such as ‘date’, ‘temperature’,
‘humidity’, ‘production_level’, and ‘energy_consumption’. The facility's management wants
to predict future energy consumption to optimize their energy planning and reduce costs.
They are particularly interested in understanding how the production level affects energy
consumption. The dataset is stored on a local server and can be accessed via the ‘/data/energy_
consumption.csv’ path.
##Task Part from FIG. 1:
Assuming all the functions are implemented, your task is to directly invoke the single Python
function that will solve this task.

### 4.0 Example Self-Supervised Activities for Explainer Accuracy Measurement

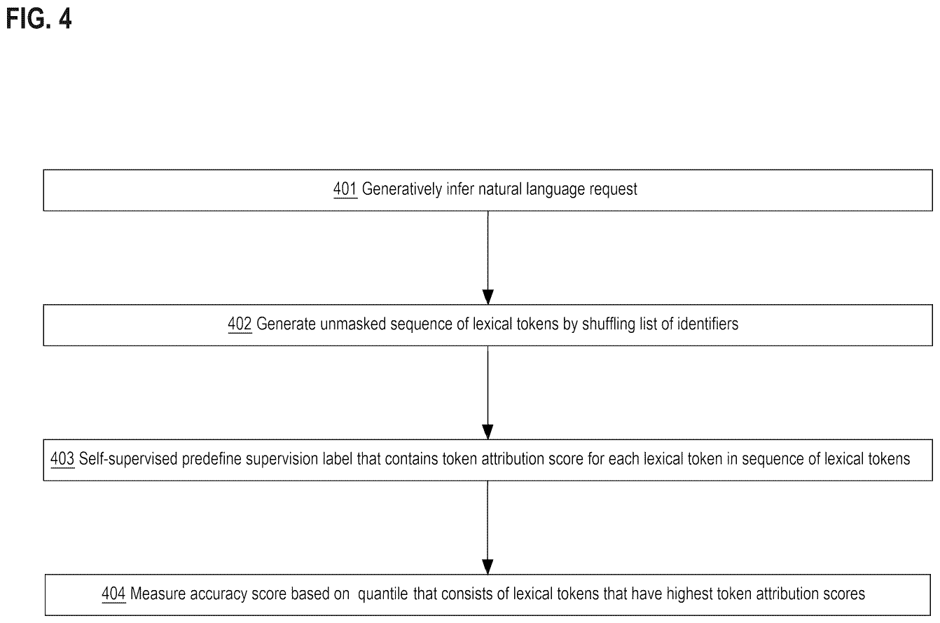

FIG. 4 is a flow diagram that depicts example self-supervised activities for measuring accuracy of token attribution explainers 131-132. The process of FIGS. 2-4 are compatible, and their steps may be combined or interleaved. Preparatory steps 401-403 may occur before the process of FIG. 2.

In FIG. 1, unmasked sequence of lexical tokens 111 is one datapoint in the unmasked corpus. As shown in prompt parts 121 in FIG. 1 as discussed earlier herein, the context part and the task part consist solely of natural language. Each repetition of the sequence of steps 401-403 generates an unmasked sequence of lexical tokens (e.g. 111, i.e. part of an unmasked datapoint) for inclusion in the unmasked corpus. Populating the unmasked corpus with datapoints may entail repeated invocations of step 401. In step 401, a large language model (LLM, e.g. 109) generatively infers a natural language request that consists of the context part and the task part. In an embodiment in step 401, LLM 109 accepts an input prompt that contains: a) the correct choice part but not the wrong choice parts and b) a different task part (not shown) that instructs LLM 109 to generate the shown context part and the shown task part.

Step 402 generates unmasked sequence of lexical tokens 111 by shuffling multiple choice parts such as the three choice parts shown in prompt parts 121 in FIG. 1 Shuffling by step 402 entails randomly reordering the list of choices to increase accuracy by avoiding positional learning bias.

Step 403 self-supervised predefines token attribution scores label 123 as a supervision label that contains token attribution score for each lexical token T1-T16 in sequence of lexical tokens 111, as discussed earlier herein. Herein, self-supervision is fully automated and does not entail human intervention nor human expertise.

When repetition of step 403 ceases, the unmasked corpus is ready. Between steps 403-404, steps 201-205 of FIG. 2 may generate the masked corpus. Step 404 may be a sub-step of step 208 that is a sub-step of step 206. Step 404 measures accuracy score 161 based on top quantile Q1 in FIG. 1 that consists of lexical tokens T4-T6 and T16 that have highest respective token attribution scores A4-A6 and A16.

### 5.0 Example Equations as Explainer Accuracy Metrics

FIG. 5 shows example equations 501-504 that are mathematical formulae that step 404 of FIG. 4 may implement to self-supervised measure accuracy scores 161-162 of respective token attribution explainers 131-132. In equations 501-502 is subscript ‘2’ that indicates numeric base two. In equations 501-504 is Q that is a percentage that defines the size of top quantile Q1 in FIG. 1 as discussed below.

In natural language processing (NLP), perplexity is a metric that, herein, measures how accurately large language model (LLM) 109 can predict a function invocation expression as a sequence of lexical tokens. Perplexity can be used to quantify LLM 109's surprise, confusion, or uncertainty when encountering an unfamiliar input context. A lower perplexity score indicates that LLM 109 is more confident and less perplexed about the input it is processing. Low perplexity indicates that LLM 109 is fluent in the programing language's (e.g. Python) structure and patterns. Perplexity is inversely correlated to accuracy of function invocation expression generation. For information gain or loss equations 501-502, techniques for measuring LLM perplexity including base two are presented in “The Relationship Between Perplexity And Entropy In NLP” by Ravi Charan on Sep. 24, 2020 available at https://www.topbots.com/perplexity-and-entropy-in-nlp/ that is incorporated by reference in its entirety herein.

Equations 501-504 are example fidelity metrics with techniques that are based on perturbation of an unmasked linguistic prompt (e.g. 111 in FIG. 1) to generate masked prompts (e.g. 112-114). To evaluate the respective quality (i.e. fidelity) of token attribution explainers 131-132 and their alignment with LLM 109's learned internal process, the sole input is the unmasked corpus that includes many unmasked samples including, as shown in FIG. 3, sample 311 as generated by step 3 from which variously masked sequences of lexical tokens 112-114 may be generated. That is, equations 501-504 are based on the masked corpus that includes the unmasked corpus. Sequences of lexical tokens 111-114 are respective inputs accepted by LLM 109, and token attribution scores A1-A16 and B1-B16 are computed from LLM 109's outputs by token attribution explainers 131-132. Fidelity (a.k.a. faithfulness) is a token attribution explainer's quantitatively measurable ability to explain LLM 109's decision-making process. Fidelity is measured using information-theoretic metrics. The approach herein is robust even if LLM 109 generates incorrect outputs or hallucinates. This robustness is because a reliable token attribution explainer should identify the input tokens contributing to the output, regardless of the correctness of the output. For example, nonintrusive token attribution explainer 131 may have low fidelity if inferentially generated source logic 106 is correct and local explanation 141 is incorrect. Conversely, fidelity may be high if inferentially generated source logic 106 is incorrect and local explanation 141 is correct.

As discussed earlier herein, token attribution scores label 123 provides self supervision for measurement of accuracy scores 161-162. Measurement of each of accuracy scores 161-162 may be facilitated by applying any one or combination of equations 501-504. Self supervised application of information gain or loss equations 501-502 may entail comparing perplexities that are based on the top quantile of token attribution scores label 123. In information gain or loss equations 501-502, log2P2 is base-2 perplexity that may be measured as discussed above.

Any of equations 501-504 may be repeatedly reused to process a whole corpus. For example, accuracy score 161 may be an average of many invocations of equation 501 for many datapoints.

Equation 501 measures comprehensiveness (i.e. necessity) as Information Loss at Top-Q % Perturbation. Based on two measured perplexities, equation 501 evaluates the information loss (i.e. increase in perplexity) from perturbing (i.e. masking) the top quantile (i.e. Q %) of tokens according to token attribution scores label 123. For example as shown in FIG. 1, Q (not shown) is 25, and shown top quantile Q1 is a quartile. In token attribution scores label 123, the top quartile contains only four shaded lexical tokens T6, T12, and T14-T15, which are masked in less-masked sequence of lexical tokens 112. That is in equation 501, 100% input preservation is unmasked sequence of lexical tokens 111, and Q % input perturbation is less-masked sequence of lexical tokens 112.

Equation 502 measures sufficiency as Information Gain at Top-Q % Preservation. Based on two measured perplexities, equation 502 evaluates the information gain (i.e. decrease in perplexity) from preserving (i.e. not masking) the top quantile of tokens according to token attribution scores label 123. In equation 502, 100% input perturbation is fully-masked sequence of lexical tokens 114, and Q % input preservation is more-masked sequence of lexical tokens 113.

Equation 503 measures Top-Q % Spatial Precision as the proportion of the top-Q % of positive input tokens, ranked by their token attribution scores (e.g. A1-A16), that occur in the regions of the input deemed relevant per token attribution scores label 123. Equation 503 is based on true or false 152 for top quantile Q1 that, as shown in FIG. 1, contains three true positives, shown as TP(Q %) in equation 503, and one false positive shown as FP(Q %). Equation 503 may, for example, be based on a confusion matrix.

Equation 504 measures Top-Q % Concentration. In an embodiment of equation 504: a) the top-Q % of tokens are the four tokens shown shaded in token attribution scores label 123, b) positive tokens are the four tokens shown positive for in top quantile 153, and c) sets (a) and (b) may share some (e.g. most) tokens. In equation 504, T(Q %) is the top-Q % of positive tokens, which is the intersection (i.e. conjunction) of (a) and (b). R represents the set of tokens located in the regions of the input deemed relevant (i.e. based on token attribution scores label 123). In equation 504, ai is the attribution value of input token i. In equation 504, 1(ai>0) is an indicator function that evaluates to zero or one as, for example, a Boolean.

### HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

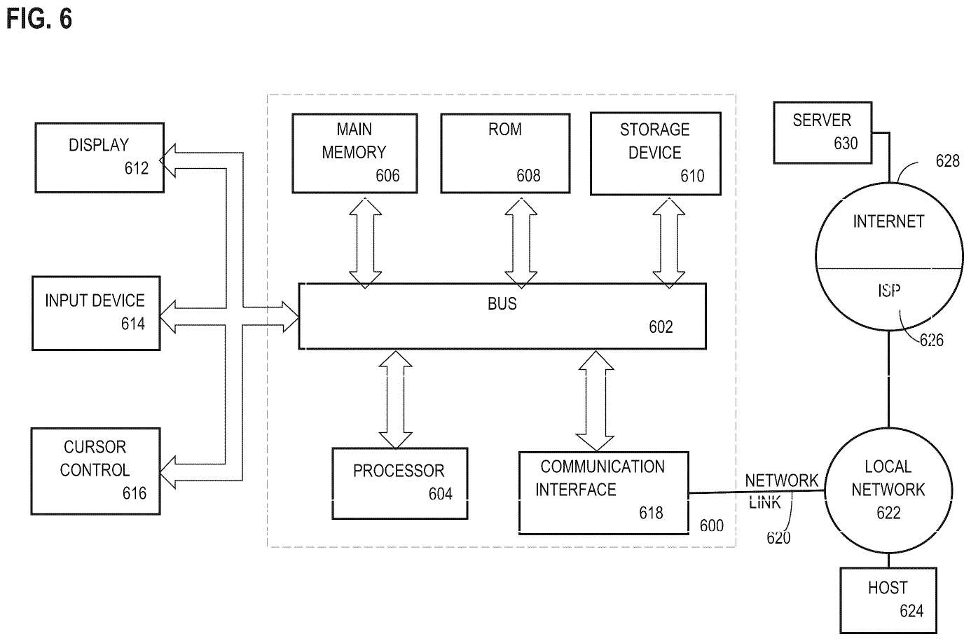

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### SOFTWARE OVERVIEW

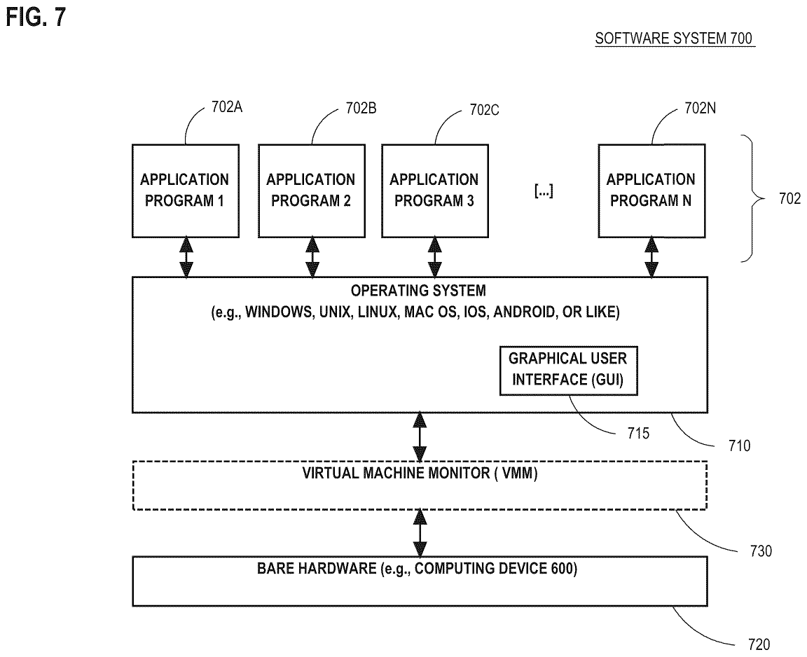

FIG. 7 is a block diagram of a basic software system 700 that may be employed for controlling the operation of computing system 600. Software system 700 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 700 is provided for directing the operation of computing system 600. Software system 700, which may be stored in system memory (RAM) 606 and on fixed storage (e.g., hard disk or flash memory) 610, includes a kernel or operating system (OS) 710.

The OS 710 manages low-level aspects of computer operation, including managing execution of processes, memory allocation, file input and output (I/O), and device I/O. One or more application programs, represented as 702A, 702B, 702C . . . 702N, may be “loaded” (e.g., transferred from fixed storage 610 into memory 606) for execution by the system 700. The applications or other software intended for use on computer system 600 may also be stored as a set of downloadable computer-executable instructions, for example, for downloading and installation from an Internet location (e.g., a Web server, an app store, or other online service).

Software system 700 includes a graphical user interface (GUI) 715, for receiving user commands and data in a graphical (e.g., “point-and-click” or “touch gesture”) fashion. These inputs, in turn, may be acted upon by the system 700 in accordance with instructions from operating system 710 and/or application(s) 702. The GUI 715 also serves to display the results of operation from the OS 710 and application(s) 702, whereupon the user may supply additional inputs or terminate the session (e.g., log off).

OS 710 can execute directly on the bare hardware 720 (e.g., processor(s) 604) of computer system 600. Alternatively, a hypervisor or virtual machine monitor (VMM) 730 may be interposed between the bare hardware 720 and the OS 710. In this configuration, VMM 730 acts as a software “cushion” or virtualization layer between the OS 710 and the bare hardware 720 of the computer system 600.

VMM 730 instantiates and runs one or more virtual machine instances (“guest machines”). Each guest machine comprises a “guest” operating system, such as OS 710, and one or more applications, such as application(s) 702, designed to execute on the guest operating system. The VMM 730 presents the guest operating systems with a virtual operating platform and manages the execution of the guest operating systems.

In some instances, the VMM 730 may allow a guest operating system to run as if it is running on the bare hardware 720 of computer system 600 directly. In these instances, the same version of the guest operating system configured to execute on the bare hardware 720 directly may also execute on VMM 730 without modification or reconfiguration. In other words, VMM 730 may provide full hardware and CPU virtualization to a guest operating system in some instances.

In other instances, a guest operating system may be specially designed or configured to execute on VMM 730 for efficiency. In these instances, the guest operating system is “aware” that it executes on a virtual machine monitor. In other words, VMM 730 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### CLOUD COMPUTING

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### MACHINE LEARNING MODELS

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### ARTIFICIAL NEURAL NETWORKS

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### ILLUSTRATIVE DATA STRUCTURES FOR NEURAL NETWORK

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### BACKPROPAGATION

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### AUTOENCODER

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 25;2(1):1-18 by Jinwon An et al.

### PRINCIPAL COMPONENT ANALYSIS

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### RANDOM FOREST

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

### LARGE LANGUAGE MODELS (LLMS)

In some illustrative embodiments, the mechanisms of the illustrative embodiments include or work in conjunction with Large Language Models (LLMs). LLMs are a class of artificial intelligence (AI) systems that employ deep learning architectures, such as transformer-based neural networks, to model and generate human-like natural language. These models are capable of understanding, processing, and generating textual content with high fluency and contextual relevance. Exemplary instances of such models include ChatGPT developed by OpenAI and Gemini (previously known as “Bard”) developed by Google LLC.

At their core, LLMs are statistical models trained on large-scale collections of unstructured natural language text. During training, the LLM is presented with sequences of tokens (typically representing words or sub-words) from these collections, or “corpora”, and learns to predict the probability distribution of the next token in the sequence, given the preceding context. This predictive modeling approach allows the LLM to learn syntactic structures, semantic relationships, contextual dependencies, and pragmatic cues present in natural language. The result is a system capable of performing a wide range of language-related tasks, including but not limited to, language modeling, text generation, machine translation, summarization, question answering, sentiment analysis, classification, and information retrieval.

The architecture of a typical LLM is built upon a deep neural network composed of multiple layers of self-attention and feedforward transformations, such as in a transformer architecture which uses a self-attention mechanism to process sequential data, such as text or audio in parallel rather than sequentially like a recurrent neural network (RNN). Each layer consists of multiple attention heads, layer normalization components, and residual connections. These components facilitate the model's ability to process and retain long-range dependencies across a text input. The model encodes input text as high-dimensional embeddings and transforms these embeddings through successive non-linear operations to derive context-aware representations, which ultimately inform the generation of output tokens.

As mentioned above, training an LLM requires exposure to a vast dataset of unstructured text, which may include web pages, books, articles, code repositories, and other publicly or commercially available sources. The training process typically involves unsupervised or self-supervised learning, wherein the model minimizes a loss function that penalizes inaccurate predictions of masked or subsequent tokens. Gradient-based optimization techniques, such as stochastic gradient descent (SGD) or the like, are employed to update the millions of model parameters over many iterations.

Once trained, an LLM is deployed for performing inference operations. As noted above, LLMs operate primarily in an autoregressive manner in that they are given an input sequence, and the LLM predicts the next most probable token in the sequence. The model then iteratively repeats this process, generating sequences of output tokens based on the evolving context. The input provided to the LLM is often referred to as a “prompt” and there is an entire area of study, referred to as “prompt engineering”, directed to the creation of appropriate prompts to obtain the best results from an LLM.

The LLM may be accessed through an interface or Application Programming Interface (API) that allows users to interact with the LLM via such prompts. The prompts themselves are a structured input string comprising one or more portions including an instructional portion, contextual portion, and operational portion. The instructional portion provides a natural language description of the task to be performed by the model. For example, “Translate the following paragraph into English” or “Summarize the main points of this document.” The contextual portion specifies the data or content upon which the task is to be executed, e.g., a body of text, a hyperlink to an online resource, a filename, a structured dataset, or the like. The data may be passed directly or indirectly, such as by referencing an external storage location.

An optional operational portion may be provided in the prompt to the LLM. The operational portion specifies software tools or executable utilities that the LLM is permitted or instructed to invoke when performing the requested task as specified in the instructional portion. Such tools can include functions for mathematical computation, database access, image processing, code execution, or custom analytics workflows. These tools may operate as discrete programs or callable APIs, and their output may be integrated into the LLM's processing pipeline to generate the response to the prompt.

In some cases, LLM prompts may further include formatting or template cues, few-shot examples, and special tokens or modifiers. The formatting or template cues may specify formatting constraints or delimiters to influence the structure of the output, e.g., “the output should be in JSON format”, use of bullet points, provide Extensible Markup Language (XML) tags. The few-shot examples may provide input-output pairs that serve as in-context demonstrations for the LLM to learn from within the prompt itself (also referred to as “few-shot learning”). The special tokens or modifiers may represent roles, commands, or model behaviors that the LLM is to exhibit.

When a prompt is input to a LLM, the prompt is first tokenized, i.e., transformed into a sequence of tokens using a tokenizer specific to the LLM's vocabulary. These tokens are then input into the LLM's embedding layers and processed sequentially via multi-headed self-attention mechanisms distributed across multiple transformer layers. The LLM generates its output token-by-token, with each subsequent token generated based on both the prompt and all previously generated tokens. This process allows the LLM to complete sentences, perform logical inference, or generate structured data, depending on the original prompt.

The LLM's internal representations are heavily influenced by the prompt's wording, token length, semantic specificity, and syntactic structure. Thus, small changes to a prompt, such as reordering phrases, changing tense, or altering punctuation, can yield significantly different outputs, underscoring the need for precise prompt engineering in production settings.

Inference in LLMs often involves probabilistic sampling from a learned distribution, which may be controlled via parameters such as temperature, top-k, or top-p (nucleus sampling). These mechanisms influence the diversity and determinism of the LLM's outputs. Advanced LLM implementations may further incorporate memory modules, retrieval augmentation (e.g., RAG models), multi-modal processing capabilities (e.g., combining text with images or audio), or system-level orchestration that allows for multi-agent collaboration or tool-assisted reasoning. Additionally, guardrails and alignment techniques may be applied to constrain the model's outputs to predefined safety or ethical guidelines.

The combination of scalable deep learning, prompt-based interaction, and extensible tool use makes LLMs a flexible platform for general-purpose AI applications across various domains such as education, law, healthcare, programming, and customer service.

### PROMPT ENGINEERING

As noted above, an important area of study in modern AI systems involving the use of LLMs is the area of prompt engineering since the output of an LLM is highly influenced by the particular content and configuration of the prompt that is input to it. Prompt engineering is a systematic process for designing and structuring input prompts in order to elicit desired behavior or output from a LLM. As the behavior of LLMs is highly dependent on the phrasing, structure, and context of the input prompt, prompt engineering involves strategic manipulation of prompts to achieve predictable and optimized outputs. Importantly, prompt engineering does not require retraining or fine-tuning of the underlying model(s) of the LLM. Instead, prompt engineering leverages the inherent capabilities of pretrained models by modifying the natural language or token-based instructions provided to the model so as to direct the model behavior in a desired direction.

The term “prompt” refers to the complete input provided to the LLM to induce the LLM to generate a particular output. Prompts can vary in structure depending on the task, with example elements of a prompt having been described previously.

Prompt engineering generally comprises a multi-step iterative process, including task definition, prompt design, prompt testing, evaluation and optimization, prompt finalization, and prompt versioning and adaptation. With the task definition step, the specific behavior or output required from the LLM is identified, e.g., classification, code generation, legal summarization, etc. In the prompt design step, an initial prompt is constructed that coveys the task and context, which may require careful selection of natural language phrasing, formatting requirements, and providing of examples and constraints for the LLM task being requested. The prompt testing step involves providing the constructed prompt to the LLM and observing the results generated by the LLM. The evaluation and optimization step, which may be performed iteratively with the prompt design and prompt testing steps, involves assessing the output against desired criteria, e.g., accuracy, completeness, tone, etc., and refining the prompt accordingly. The prompt finalization step involves locking in a prompt configuration for production use, such as storage in a prompt repository or otherwise made available for reuse, or integration into downstream applications. The optional prompt versioning and adaptation step involves maintaining multiple versions of prompts adapted for different models, user intents, or performance trade-offs.

Prompt engineering is an important enabling technique in various domains, including conversational agents and chatbots, legal, medical, or technical summarization, structured data extraction, automated code generation and debugging, AI-assisted creativity tools (e.g., story or image generation), and decision support systems. Prompt engineering enables these applications to be implemented without additional training data, thereby reducing development costs and enabling rapid prototyping.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving:
an unmasked sequence of lexical tokens that includes a natural language request and
an inferentially generated source logic that can execute the natural language request;
identifying a plurality of sequences of lexical tokens that include: the unmasked sequence of lexical tokens, a less-masked sequence of lexical tokens, a more-masked sequence of lexical tokens, and a fully-masked sequence of lexical tokens, wherein said identifying comprises:
generating the less-masked sequence of lexical tokens by masking less than half of the lexical tokens in the unmasked sequence of lexical tokens,
generating the more-masked sequence of lexical tokens by masking more than half of the lexical tokens in the unmasked sequence of lexical tokens, and
generating the fully-masked sequence of lexical tokens by masking all of the lexical tokens in the unmasked sequence of lexical tokens;
generating a plurality of accuracy scores in a memory in a first computer, including performing for each token attribution explainer of a plurality of token attribution explainers:
a) generating, by the token attribution explainer, a plurality of local explanations of the token attribution explainer that includes, for each sequence of lexical tokens in the plurality of sequences of lexical tokens, a local explanation of the token attribution explainer that contains a token attribution score for each lexical token in the sequence of lexical tokens, and
b) measuring, from the plurality of local explanations of the token attribution explainer and storing, in the plurality or accuracy scores, an accuracy score of the token attribution explainer;
selecting a most accurate token attribution explainer that has a highest semantic accuracy of the plurality of token attribution explainers by accessing the plurality of accuracy scores in the memory;
deploying into a second computer, without the plurality of token attribution explainers, the most accurate token attribution explainer; and
generating, by the most accurate token attribution explainer in the second computer, and displaying a local explanation of a new inferentially generated source logic that can execute a new natural language request.

2. The method of claim 1 further comprising self-supervised predefining a supervision label that contains a token attribution score for each lexical token in a sequence of lexical tokens in the plurality of sequences of lexical tokens.

3. The method of claim 2 wherein the supervision label contains for each lexical token in a declaration of a subroutine at least one selected from a group consisting of: a positive token attribution score and a nonpositive token attribution score.

4. The method of claim 3 wherein the declaration of the subroutine comprises at least one selected from a group consisting of documentation generation data and a subroutine signature.

5. The method of claim 1 further comprising generating the unmasked sequence of lexical tokens by shuffling a list of identifiers.

6. The method of claim 5 wherein the list of identifiers is a list of subroutine names.

7. The method of claim 1 wherein for each token attribution explainer of the plurality of token attribution explainers, said measuring is based on a quantile that consists of lexical tokens that have highest token attribution scores in a particular sequence of lexical tokens in the plurality of sequences of lexical tokens.

8. The method of claim 1 wherein for each token attribution explainer of a plurality of token attribution explainers, the accuracy score of the token attribution explainer comprises at least one accuracy score selected from a group consisting of:
a necessity score that is a ratio of two integer counts and
a sufficiency score that is a ratio of two weighted sums.

9. The method of claim 1 further comprising generatively inferring the natural language request.

10. The method of claim 1 wherein the source logic is dynamically typed.

11. One or more non-transitory computer-readable media storing instructions that, when executed by one or more processors, cause:
receiving:
an unmasked sequence of lexical tokens that includes a natural language request and
an inferentially generated source logic that can execute the natural language request;
identifying a plurality of sequences of lexical tokens that include: the unmasked sequence of lexical tokens, a less-masked sequence of lexical tokens, a more-masked sequence of lexical tokens, and a fully-masked sequence of lexical tokens, wherein said identifying comprises:
generating the less-masked sequence of lexical tokens by masking less than half of the lexical tokens in the unmasked sequence of lexical tokens,
generating the more-masked sequence of lexical tokens by masking more than half of the lexical tokens in the unmasked sequence of lexical tokens, and
generating the fully-masked sequence of lexical tokens by masking all of the lexical tokens in the unmasked sequence of lexical tokens;
generating a plurality of accuracy scores in a memory in a first computer, including performing for each token attribution explainer of a plurality of token attribution explainers:
a) generating, by the token attribution explainer, a plurality of local explanations of the token attribution explainer that includes, for each sequence of lexical tokens in the plurality of sequences of lexical tokens, a local explanation of the token attribution explainer that contains a token attribution score for each lexical token in the sequence of lexical tokens, and
b) measuring, from the plurality of local explanations of the token attribution explainer and storing, in the plurality or accuracy scores, an accuracy score of the token attribution explainer;
selecting a most accurate token attribution explainer that has a highest semantic accuracy of the plurality of token attribution explainers by accessing the plurality of accuracy scores in the memory;
deploying into a second computer, without the plurality of token attribution explainers, the most accurate token attribution explainer; and
generating, by the most accurate token attribution explainer in the second computer, and displaying a local explanation of a new inferentially generated source logic that can execute a new natural language request.

12. The one or more non-transitory computer-readable media of claim 11 wherein the instructions further cause self-supervised predefining a supervision label that contains a token attribution score for each lexical token in a sequence of lexical tokens in the plurality of sequences of lexical tokens.

13. The one or more non-transitory computer-readable media of claim 12 wherein the supervision label contains for each lexical token in a declaration of a subroutine at least one selected from a group consisting of: a positive token attribution score and a nonpositive token attribution score.

14. The one or more non-transitory computer-readable media of claim 13 wherein the declaration of the subroutine comprises at least one selected from a group consisting of documentation generation data and a subroutine signature.

15. The one or more non-transitory computer-readable media of claim 11 wherein the instructions further cause generating the unmasked sequence of lexical tokens by shuffling a list of identifiers.

16. The one or more non-transitory computer-readable media of claim 15 wherein the list of identifiers is a list of subroutine names.

17. The one or more non-transitory computer-readable media of claim 11 wherein for each token attribution explainer of the plurality of token attribution explainers, said measuring is based on a quantile that consists of lexical tokens that have highest token attribution scores in a particular sequence of lexical tokens in the plurality of sequences of lexical tokens.

18. The one or more non-transitory computer-readable media of claim 11 wherein for each token attribution explainer of a plurality of token attribution explainers, the accuracy score of the token attribution explainer comprises at least one accuracy score selected from a group consisting of:
a necessity score that is a ratio of two integer counts and
a sufficiency score that is a ratio of two weighted sums.

19. The one or more non-transitory computer-readable media of claim 11 wherein the instructions further cause generatively inferring the natural language request.

20. The one or more non-transitory computer-readable media of claim 11 wherein the source logic is dynamically typed.
